(19) United States
(12) Patent Application Publication
(10) Pub. No.: US 2015/0239603 A1
(43) Pub. Date: Aug. 27, 2015

(54) CONTAINER FOR A HEALTH PRODUCT HOUSING INSIDE AN INFORMATION LEAFLET AND A METHOD FOR MAKING THE CONTAINER

(71) Applicant: ESSENTRA PACKAGING S.r.l., Podenzano (Piacenza) (IT)

(72) Inventors: Enrico Folchini, Rho (Milano) (IT); Tullio Cottignoli, Cervia (Ravenna) (IT); Mario Casazza, Rivergaro (Piacenza) (IT)

(21) Appl. No.: 14/415,648

(22) PCT Filed: Jul. 17, 2013
(86) PCT No.: PCT/IB2013/055865

§ 371 Date: Jan. 19, 2015

(30) Foreign Application Priority Data
Jul. 20, 2012 (IT) BO2012A000397

(51) Int. Cl. B65D 5/42; B65D 5/02; B65C 9/20; B65D 85/00; B65C 3/06; A61J 1/03; B65D 65/14

(52) U.S. Cl. CPC B65D 5/4233; A61J 1/03; B65D 5/02; B65D 5/4204; B65D 5/4216; B65D 65/14; B65D 85/70; B65C 3/06; B65C 9/20

(57) ABSTRACT

Container for a health product belonging to the category of drugs, cosmetics, food supplements or the like, which houses inside an information leaflet relative to the product contained therein. The information leaflet, folded on itself, is fixed to the container by a label made of plastic material, wherein the latter is permanently fixed to an outer face the information leaflet, folded on itself by first adhesive substance, and stably and removably fixed by a second adhesive substance to the inner face of the blank from which the container is obtained by folding and gluing.

### TECHNICAL FIELD

The present invention relates to a container for a health product belonging to the category of drugs, cosmetics, food supplements or the like, housing inside an information leaflet relative to the product contained. This invention also relates to a method for making the above-mentioned container.

### BACKGROUND Art

For the sake of simplicity and without limiting the scope of this invention, explicit reference will be made below to drugs.

Drugs, depending on their type, their composition and their usage, are generally contained inside packages such as blister packs, bottles, tubes, jars, bags or the like.

These packages are in turn housed, together with the relative instruction leaflets, inside the containers which constitute the final cases for the sale to the consumer.

The instruction leaflets are printed with important information for the consumer, such as composition of the drug, therapy instructions, dosage, side effects, means of storage, etc.

The instruction leaflets are normally folded several times along a plurality of parallel lines to reduce the dimensions. After this folding, each instruction leaflet has the shape of a strip the longitudinal dimension of which, that is, in the direction of the parallel folding lines, can be further reduced if necessary by means of one or more folds transversal to the above-mentioned parallel folding lines.

Each container is generally made from a respective card blank, which is folded and glued in such a way as to take on the shape of a box, generally parallelepiped.

More specifically, the blank is firstly folded and glued to obtain a closed and flat carton; next, the carton is put into shape, that is, it is opened so as to form the inner space of the container designed to house the packed drug and the relative instruction leaflet.

Generally, the formation of the flat carton is performed at paper industry firms, that is, at the premises of the carton manufacturer, whilst the opening of the carton for forming the container is performed at the site for boxing the drug.

One of the most commonly adopted solutions for inserting an instruction leaflet in its container provides for using the packed drug as the means for pushing the leaflet inside the container. In other words, the packed drug, for example a bottle containing pills, in its motion for inserting inside the container, intercepts the instruction leaflet and pushes it inside the container folding it in a U-shape about its pushing end; for example, in the case of the bottle, about its bottom wall. Another solution adopted is that of inserting the folded leaflet inside the container and then positioning the product inside the container.

This latter operation is sometimes difficult due to the limited dimensions of the container which must contain both the packed drug and the instruction leaflet, and this may cause damage to the container and/or the instruction leaflet and/or the packed drug.

For this reason, techniques have been developed over recent years which provide for the pre-insertion of the instruction leaflet inside the carton in the step for forming the carton, that is, at paper industry firms or at the premises of the carton manufacturer.

The set consisting of the instruction leaflet and the carton is then dispatched to the site for boxing the drug.

However, this technique has some drawbacks, as the instruction leaflet can be lost during transport of the carton to the site for boxing the drug, or it can be damaged or come out of the container after inserting the packed drug in the container. In particular, it is necessary to avoid the loss of the leaflet from the carton or from the container, since the regulations for pharmaceutical products require that there is always an instruction leaflet for every box containing the product which must be administered to the patient.

In order to overcome this circumstance, various solutions have been proposed with the aim of fixing the instruction leaflet inside the carton. All these solutions provide for the creation of a compartment inside the carton and designed to contain the instruction leaflet.

According to the most common practice in the prior art, in the process for forming the set consisting of the carton and the instruction leaflet, the latter can be fixed to the blank in its correct position by means of a spot of glue, before the blank is folded and glued to obtain the carton and the compartment for containing the instruction leaflet.

The function of the glue is solely that of temporarily fixing the position of the instruction leaflet on the blank, before the instruction leaflet is stably associated with the carton, inside the respective containment compartment.

However, even this technique is not without drawbacks. The above-mentioned spot of glue can, despite the minimum quantity of glue, tear the instruction leaflet during its extraction from the container by the consumer, with the potential loss of some information contained therein.

Even without a tear, the spot of glue can cause marks, discolouring or in general a poor legibility of the characters printed on the instruction leaflet. On the other hand, without the temporary fixing assured by the spot of glue, there is a high risk that the information leaflet will not be positioned correctly on the blank during folding of the latter, with possible damage both to the leaflet and the blank in the process for forming the above-mentioned compartment or the loss of the leaflet in the steps preceding the folding of the blank.

### DISCLOSURE OF THE INVENTION

The aim of this invention is to overcome the above-mentioned drawbacks.

According to the invention, this aim is achieved by providing a container for a health product belonging to the category of drugs, cosmetics, food supplements or the like, housing inside an information leaflet relative to the product contained and comprising the technical features described in one or more of the appended claims.

In order to fulfil the above-mentioned aim, a method is also proposed according to this invention for making the above-mentioned container, according to one or more of the appended claims.

### BRIEF DESCRIPTION OF DRAWINGS

The technical features of the invention, with reference to the above aim, are clearly described in the claims below and its advantages are apparent from the detailed description which follows, with reference to the accompanying drawings which illustrate a preferred, non-limiting example embodiment of the invention, and in which:

FIG. 1 is a perspective view, with some parts cut away for clarity, of a container for a health product, made in accordance with this invention;

FIG. 2 illustrates an information leaflet included in the container of FIG. 1;

FIG. 3 illustrates a blank from which the container of FIG. 1 is obtained;

FIG. 4 illustrates the blank of FIG. 3 to which the information leaflet of FIG. 2 has been associated; and

FIG. 5 schematically illustrates a packaging line for the association of the information leaflet of FIG. 2 to the blank of FIG. 3.

### DETAILED DESCRIPTION OF PREFERRED EMBODIMENTS OF THE INVENTION

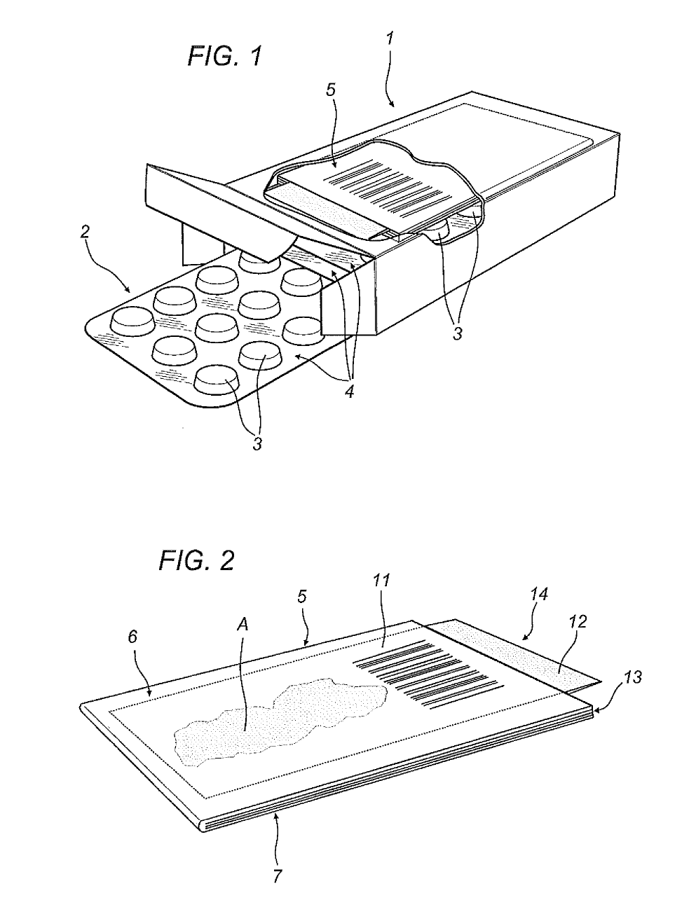

In FIG. 1 numeral 1 denotes a container 2 for a health product.

The term “health product” means a product belonging to the category of drugs, or cosmetics, food supplements, or the like.

The product 2, depending on its type, its composition and its usage, can be contained inside various type of packages which guarantee the correct preservation, such as blister packs, bottles, tubes, jars, bags or the like. In the example below the product 2 consists of a set of pills 3 packed in groups inside one or more blister packs 4.

The container 1 constitutes the final case for the sale to the consumer, and houses inside, as well as the product 2, also an information leaflet 5 relative to the product 2 contained therein.

The instruction leaflet 5 is printed with important information for the consumer, such as composition of the product 2, therapy instructions, dosage, side effects, means of storage, etc.

The instruction leaflet 5 can be folded several times along a plurality of parallel lines to reduce the dimensions. After this folding, the instruction leaflet 5 has the shape of a strip the longitudinal dimension of which, that is, in the direction of the parallel folding lines, can be further reduced if necessary by means of one or more folds transversal to the above-mentioned parallel folding lines.

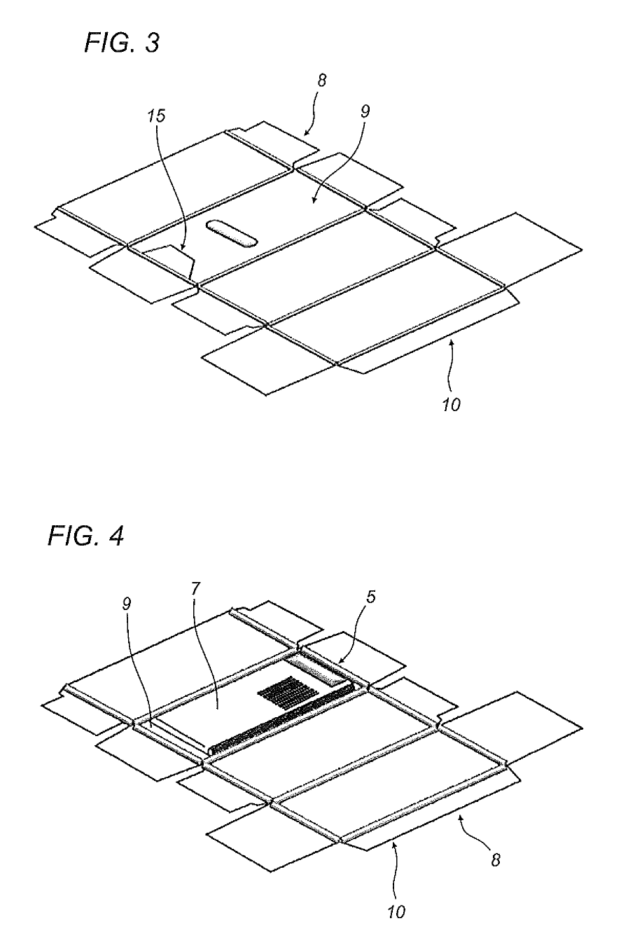

In its final folded shape, shown in more detail in FIG. 2, the information leaflet 5 has two outer faces 6, 7 with large planar surfaces, located opposite each other.

The container 1 is made from a card blank 8, shown in FIG. 3, which is folded (and then glued) in such a way as to take on the shape of a box, generally parallelepiped as in the example below.

The blank 8 has an inner face 9, designed to surround the inner space of the container 1, and an outer face 10, bearing information for the sale of the product 2 contained in the container 1.

As illustrated in FIGS. 2 and 4, the container also comprises a label 11 interposed between a first outer face 6 of the folded information leaflet 5 and the inner face 9 of the blank 8.

The label 11 is permanently fixed to the first inner face 6 of the folded information leaflet 5 by means of a first adhesive substance.

The label 11 is also stably and removably fixed (the removal is performed by the consumer) to the inner face 9 of the blank 8 by means of a second adhesive substance. The latter is denoted by the letter A in FIG. 2.

The label 11 is made of plastic material or material which will not tear or break when extracting the leaflet from the container carton.

Preferably, the label 11 is transparent.

The fact that it is transparent also allows, advantageously, the information present on the part of the information leaflet below the label to be viewed (even from outside the box if it is provided with a slot on the face of the box to which the information leaflet is attached).

label 11 covers the first outer face 6 of the folded information leaflet 5 for most of the extension (substantially for the entire extension) of the first outer face 6. Preferably, as shown in FIG. 2, the label 11 covers substantially entirely the first outer face 6 of the folded information leaflet 5.

The first and the second adhesive substances have a different adhesive force. More specifically, the adhesive force of the first adhesive substance is greater than the adhesive force of the second adhesive substance.

Preferably, the first adhesive substance consists of an adhesive layer of the label 11; in that case the label 11 is of the mono-adhesive type and the second adhesive substance consists of a layer or film of glue interposed between the label 11 and the blank 8.

In an alternative embodiment, the first and the second adhesive substances consist of respective adhesive layers of the label 11 positioned opposite each other; in that case the label 11 is of the bi-adhesive type, also in this case, preferably, with different degrees of adhesion.

The label 11 extends beyond the first outer face 6 of the information leaflet 5 and it is folded in a U shape with at least one respective flap 12 around a respective free flap 13 of the folded information leaflet 5.

The flap 12 of the label has a respective cutting line or notch (not illustrated) for favouring the transversal breaking of the flap 12 and the opening of the information leaflet 5 by the consumer.

The flap 12, according to one embodiment, could extend beyond the flap 13 and form a tab 14 which favours the detachment of the label 11 from the container 1, together with the information leaflet 5, by the consumer.

As shown in FIG. 3, the blank 8 has a respective cutting line or notch 15 for favouring the breaking of the container 1 in an access area to the set consisting of the label 11 and the information leaflet 5.

In the process for forming the container 1, the label 11 is firstly made integral with the folded information leaflet 5 and it is then glued on the inner face 9 of the blank 8.

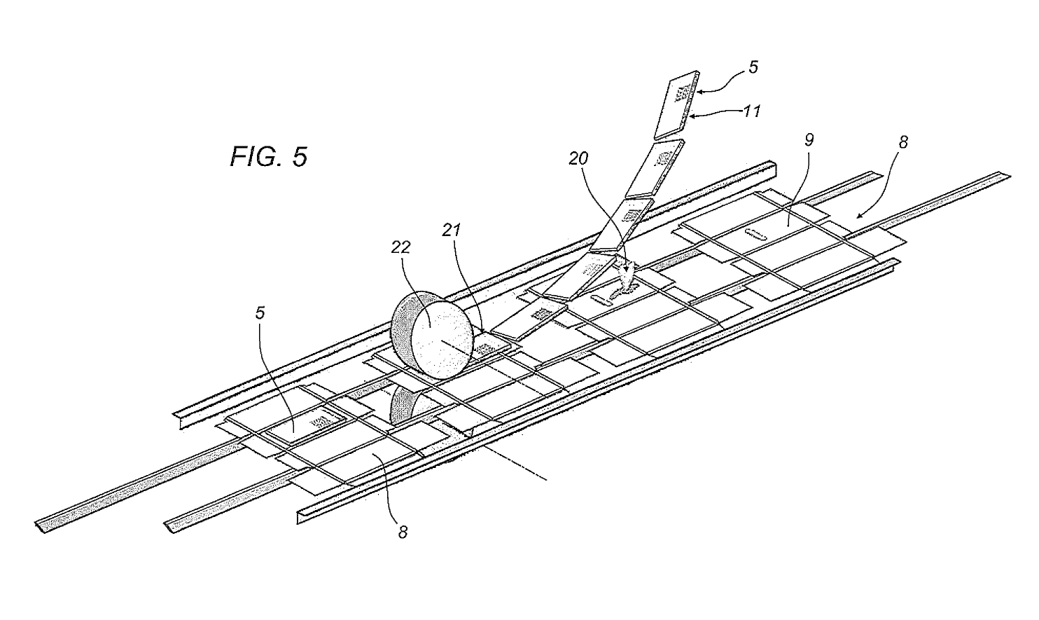

It should be noted that for a better application of the leaflet inside the container a pressing station 22 (illustrated in FIG. 5) may be necessary, which presses the leaflet integrally to the inner face of the container after application of the adhesive glue between label and inner face of the container.

This pressing station 22 has relative presser units (these units are defined by a roller in FIG. 5), designed for pressing the leaflet 5 (with relative label 11) against the surface of the container, so as to allow the application.

The presser units can consist of any type of presser device designed to apply a pressure on the leaflet 5—label 11, so as to apply it to the container.

More in detail, as schematically illustrated in FIG. 5, the label 11 is glued and pressed on the inner face 9 of the blank 8 when the blank 8 is open in a flat configuration (at an application station 21).

It should be noted that FIG. 5 shows a line for feeding blanks 8, which is designed to feed blanks 8 one after the other, in succession.

The above-mentioned pressing station 22 comprising the leaflets 5 each with relative label 11 is designed so as to apply a pressure between the leaflet 5 with label 11 and the inner face 9 of the blank 8, at the application station 21.

A gluing station 20 is positioned upstream of the application station 20, for applying the second glue on the inner face 9 of the blank 8.

Moreover, the label 11 is glued on the inner face 9 of the blank 8 before the blank 8 is folded and glued for forming a carton from which to then obtain the container 1.

The label 11 described above protects the folded information leaflet 5 from the above-mentioned second adhesive substance which, interposed between the label 11 and the blank 8, stably attaches the information leaflet 5 to the blank 8.

In other words, according to the preferred embodiment, the label 11 provides a “plastic coating” to the outer face 6 of the folded information leaflet 5, which can therefore be glued on the blank 8, substantially for its entire planar extension, without the risk of soiling the information leaflet 5 or causing a tear when extracting the information leaflet 5 from the container 1 by the consumer.

The fact of having a label 11 placed substantially along the entire outer face 6 of the folded information leaflet 5 allows the label 11 to be stably glued to the blank 8, with a relatively high dose of adhesive substance (that is, without the dose of glue causing any problems), at the same time allowing the outer face 6 of the folded information leaflet 5 to be protected from the adhesive substance.

The stable gluing of the label 11 to the blank 8 means a gluing which ensures that the information leaflet 5 remains attached to the inner part of the blank 8, so as to then allow the normal process of bending and gluing of the free flaps of the blank for forming the above-mentioned carton, without the information leaflet 5 detaching itself or breaking up.

The label 11, being made of plastic material, has a far lower surface porosity than that of the inner surface of the cardboard from which the blank 8 is made, so, at the time of the gluing and the subsequent removal of the information leaflet 5 (the removal occurs together with the label 11), the second adhesive substance used for fixing the label 11 to the blank 8 tends to remain more adhered to the inner surface of the container 1, leaving the information leaflet 5 (in the area of the label 11) free from residual adhesive substance. The second adhesive substance, even though it can potentially remain as residue on the label 11, can easily be removed before opening the information leaflet 5 without damaging the paper of the information leaflet 5.

In this context, it should be noted that the label 11 is not removed from the information leaflet 5 and, for that reason, as already mentioned, it is preferably transparent.

The invention described above is susceptible of industrial application and may be modified and adapted in several ways without thereby departing from the scope of the inventive concept. Moreover, all details of the invention may be substituted by technically equivalent elements.

1. A container for a health product belonging to the category of drugs, cosmetics, food supplements or the like, housing inside an information leaflet relative to the product contained therein; the information leaflet being folded and having, in its folded shape, two outer faces with large planar surfaces, located opposite each other; the container being obtained by folding and gluing a blank having an inner face, designed to surround the inner space of the container, and an outer face, bearing, in use, information for the sale of the product contained therein; the container comprising a label interposed between a first outer face of the folded information leaflet and the inner face of the blank; the label being permanently fixed to the first outer face of the folded information leaflet by means of a first adhesive substance, being also stably and removably fixed to the inner face of the blank by means of a second adhesive substance, and covering substantially entirely the first outer face of the folded information leaflet.

2. The container according to claim 1, wherein the label covers the first outer face of the folded information leaflet for most of the extension of the first outer face.

3. The container according to claim claim 1, wherein the label is made of plastic material.

4. The container according to claim 1, wherein the label is transparent.

5. The container according to claim 1, wherein the first and second adhesive substances have a different adhesive force.

6. The container according to claim 1, wherein the adhesive force of the first adhesive substance is greater than the adhesive force of the second adhesive substance.

7. The container according to claim 1, wherein the first adhesive substance consists of an adhesive layer of the label, the label being of the mono-adhesive type.

8. The container according to claim 7, wherein the second adhesive substance consists of a layer of glue interposed between the label and the blank.

9. The container according to claim 1, wherein the first and second adhesive substances consist of respective adhesive layers of the label positioned opposite each other, the label being of the bi-adhesive type.

10. The container according to claim 1, wherein the label extends beyond the first outer face of the information leaflet and it is folded in a U shape with at least one respective flap around a respective free flap of the folded information leaflet.

11. The container according to claim 10, wherein the flap of the label has a respective cutting line or notch for favouring the breaking of the flap and the opening of the information leaflet by the consumer.

12. The container according to claim 1, wherein the label is provided with a tab for favouring the detachment from the container, together with the information leaflet, by the consumer.

13. The container according to claim 1, wherein the blank has a respective cutting line or notch for favouring the breaking of the container in an access area to the set consisting of the label and the information leaflet.

14. A method for making a container according to claim 1, wherein the label is firstly made integral with the folded information leaflet and it is then glued on the inner face of the blank.

15. The method according to claim 14, wherein the label is glued on the inner face of the blank when the blank is open in a flat configuration.

16. The method according to claim 14, wherein the label is glued on the inner face of the blank before the blank is folded and glued for forming a carton from which to then obtain the container.

17. The method according to claim 16, wherein the label is applied on the inner face of the blank by means of a step of applying pressure, using pressing means, between the leaflet and the blank, so as to apply the label and the leaflet to the blank.
